(19) United States
(12) Patent Application Publication
(10) Pub. No.: US 2005/0008999 A1
(43) Pub. Date: Jan. 13, 2005

(54) System for determining the identity and sequence of an arbitrary number of modules

(75) Inventors: Jonathan Blossom, Charleston, SC (US); Kent Suzuki, Oakland, CA (US)

Correspondence Address: Kent Suzuki, 6722 Aitken Drive, Oakland, CA, 94611, US

(73) Assignees: BILL GOODMAN CONSULTING, LLC, Portland, ME (US); RIGHT BRAIN ELECTRONICS, LLC, Oakland, CA (US); BOPSCOTCH, LLC, Charleston, SC (US)

(21) Appl. No.: 10/616,541

(22) Filed: Jul. 10, 2003

(51) Int. Cl. G09B 25/00

(52) U.S. Cl. 434/365

(57) ABSTRACT

An apparatus in which a sequence of modules, the sequence including an arbitrary number of modules, can be attached to a base. Each module has an identity. The base initiates an identification sequence, and each module provides its identity. In some embodiments, each module identifies itself in turn, until the end of the sequence is reached. In other embodiments, each module provides its identity substantially simultaneously, and then the identities, in order, are transferred to the base. In this way the number of modules, and the order of the modules in the sequence, can be recognized. The apparatus could be used, for example, as a toy.

### BACKGROUND OF THE INVENTION

Some existing toys allow a user to compose a sequence of modules by inserting the modules into fixed slots on a base, which then identifies the modules. Some may, for example, allow a user to insert lettered tiles into slots in a base. The base identifies each letter inserted into a slot.

In this and similar examples, however, the base has a fixed number of slots, and thus can accommodate only a limited number of tiles. It would be desirable for a user to be able to compose a sequence comprising an arbitrary number of modules.

### SUMMARY OF THE INVENTION

The present invention is defined by the following claims, and nothing in this section should be taken as a limitation on those claims. In general, the invention is directed to a base and modules, wherein the base can identify the number of modules in a sequence attached to the base, and the order of modules in the sequence.

One aspect of the invention provides for an apparatus comprising a first base and a plurality of modules each having an identity. The base and modules comprise circuitry wherein, when a first module is attached to the first base, and an arbitrary number of modules of the plurality of modules are attached, directly or indirectly, to the first module, the circuitry determines an order and the identities of all attached modules.

A preferred embodiment provides for an apparatus comprising a first base; a plurality of modules, each having an identity and being directly attachable to the first base or other modules; and circuitry, wherein the circuitry determines an order and the identities of all contiguously attached modules when one of the modules is attached to the first base.

Another preferred embodiment provides for a method of identifying order and number of modules in a sequence of modules attached to a base, each module having an identity, the method comprising the base initiating an identification sequence, and each module providing its identity, wherein only one module of the sequence is directly attached to the base.

Other preferred embodiments are provided, and each of the preferred embodiments can be used alone or in combination with one another.

The preferred embodiments will now be described with reference to the attached drawings.

### BRIEF DESCRIPTION OF THE DRAWINGS

FIG. 1a through 1c illustrate each module becoming active in succession in analog embodiments of the present invention.

FIG. 2 illustrates a base with attached modules, showing the inputs and outputs for each module according to an analog embodiment of the present invention.

FIG. 3 is a circuit diagram of a preferred embodiment for a module when resistance is used to store module identity.

FIG. 4 is a circuit diagram of a preferred embodiment for a base when resistance is used to store module identity.

FIG. 5 is a flow chart for one possible implementation of software to be used with preferred embodiments of analog means of identification.

FIG. 6 is a circuit diagram of a preferred embodiment for a module when the modules comprise a shift register.

FIG. 7 illustrates leaf spring contacts.

FIG. 8 shows possible arrangements for electrical contacts for modules using analog means of identification.

### DETAILED DESCRIPTION OF THE INVENTION

In contrast to existing toys, the present invention allows a user to compose a sequence of modules attached to a base, wherein the sequence can comprise an arbitrary number of modules. Each module has an identity (corresponding to, for example, a letter, a color, a musical tone, etc.) Circuitry in the base and the sequence of modules identifies the number and order of modules in the sequence.

In this written description, the present invention will be described when used as a toy. It will be apparent, however, that the invention can be practiced in any application in which the order and number of an arbitrary sequence of modules attached to a base is to be identified.

Another possible application, for example, would be for an installation of underground pipes. If each pipe segment was able to identify itself according to the present invention, it would allow a service technician to determine exactly where to dig if there was a break in the pipeline. Alternatively, a home entertainment system could use the method of the present invention to automatically detect the brand and make of components and their connections, then use that information to program a universal remote controller, making connection suggestions: to plug a VCR between the cable box and the television, for example.

A “base” is an apparatus with at least one output port to which a module can be directly attached. A “module” has at least one input port, at least one output port, and an identity. A module can take one of many possible shapes: a block; a representative shape such as an animal, a building, a person, a trailer, or a train car, for example; any geometric shape, and so on. A module may also have some independent function, as in the underground pipeline example given above.

Each module has an identity. An identity can be or can correspond to, for example, a letter, a number, a word, a color, a shape, a sound, a musical tone, a train car, a building, a name; clearly the possibilities are virtually endless. The identity of a module can be identified by circuitry in the sequence of modules and the base, and can be different from the identity of other modules. The identity of a module may or may not be visually apparent. The identity of a module need not be unique among the modules in a sequence; i.e. the same letter or number, for example, can appear in a sequence more than once.

Modules can be attached to each other or to a base directly. For a module to be “directly attached” to a base or to another module means to be detachably in contact with it.

A sequence of modules is two or more modules in which each module is directly attached to at least one other module.

Modules can also be indirectly attached to a base or to other modules. For a module to be “indirectly attached” to a base means for it to be directly attached to a module directly attached to the base, or to be directly attached to a module or a sequence of modules, at least one module of which is directly attached to the base.

In a preferred embodiment, the base has a single port (though in other embodiments, the base may have more than one port.) A single module can be directly attached to the port. Any suitable mechanical means can be used to maintain the attachment. Pressure fittings, for example, like those used in plastic building blocks, would be effective attachment means. Many other attachment means could also be used, as long as such means provide for secure connection of the electrical contacts to be described below.

Each module preferably has an input port and an output port. In preferred embodiments, these ports are not interchangeable. The attachment means can be configured to ensure that only an input port can be directly attached to an output port and vice versa. If the user tries to directly attach an input port to another input port, for example, the attachment means won't mate, mesh, or otherwise allow mechanical attachment. Similarly, the attachment means can prevent an attempt to directly attach an output port to another output port. The attachment means can also be arranged so as to prevent electrical contacts from being connected in any orientation other than the proper one.

In a preferred embodiment, the port on the base is an output port; thus only the input port of a module can be directly attached to it. The input port of a second module can be directly attached to the output port of the first module. Similarly, the input port of a third module can be directly attached to the output port of the second module, and so on.

The base can initiate identification of the sequence of modules attached to it. A “sequence of modules” is a first module, a second module directly attached to the first module, a third module directly attached to the second module, and so on, for an arbitrary number of modules; the minimum number of modules in a sequence of modules is two. In such a sequence, the first module is directly attached to the base, and every other module is directly attached to the module before it and the module after it, except for the last module, which is directly attached only to the module before it. To identify a sequence of modules means to determine the number of modules in the sequence, the identity of each, and the order in which they appear in the sequence.

In order to identify the sequence of modules, the base initiates an identification sequence, and each module identifies itself It can also be said that each module provides its identity. In various embodiments, each module can identify itself in turn, or all modules can identify themselves substantially simultaneously.

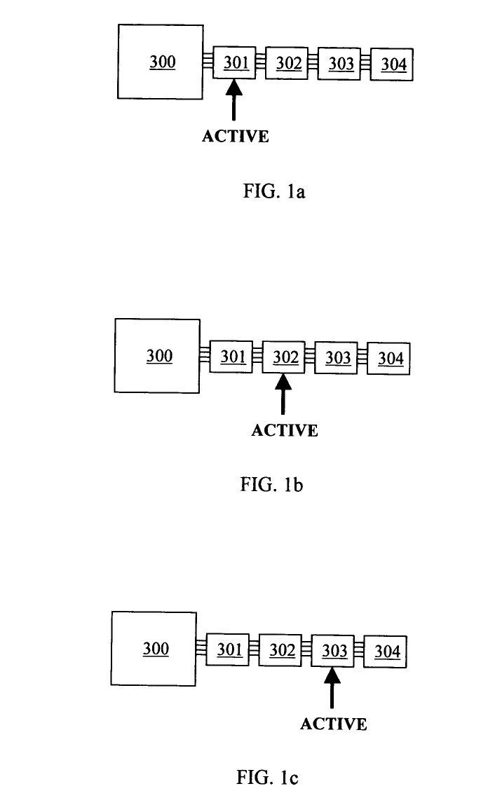

Turning to FIG. 1a, in the embodiments in which each module identifies itself in turn, the base 300 activates the first module 301, causing it to become the active module. The active module, in this case the first module 301, identifies itself, then activates the following module, in this case the second module 302; the active module (the first module 301) substantially simultaneously becomes inactive while the following module, the second module 302, becomes the active module, as in FIG. 1b. The second module 302, now the active module, identifies itself, then activates the third module 303, and substantially simultaneously becomes inactive, as in FIG. 1c. Only one module is the active module at a time. When a module is active, it identifies itself, then activates the following module, substantially simultaneously becoming inactive.

In embodiments in which the modules identify themselves substantially simultaneously, the base causes each module to provide its identity, then the identities, in order, are transferred or shifted back to the base.

The process of identifying the sequence of modules can be initiated in several ways. It can be initiated by user action: pushing a button or manipulating some other control on the base or modules, for example. Alternatively, the identifying process can take place continually: As soon as it is complete, it can begin again.

The base and modules can be employed in many configurations. An example will be given to aid discussion, but it will be understood that the example given is just one of many possible forms the present invention may take.

In this example, the modules are in the shape of blocks, each corresponding to a letter of the alphabet. Each block has an identity, which may be unique but need not be (e.g., there can be more than one block corresponding to the letter “A”.)

Many other examples can be easily envisioned, of course. Each module could have a word on it, or a color. Alternately, each module could have a different geometric shape. Each module could be shaped like a different type of train car: a caboose, coal tender, box car, etc. Each module could correspond to a building along a street: a bank, a church, a school, etc.

In preferred embodiments, the identity of each module is stored within the module. The means of storing the identity can be analog or digital.

Analog Means of Identification

If the means of storing the identity are analog, each identity corresponds to some measurable characteristic that exists in the module. In this example, a preferred embodiment, the measurable characteristic can be resistance; thus the analog means of storing the identity of a module comprises a resistor. It will be apparent to one skilled in the art, however, that other quantities can be measured instead of resistance, such as capacitance, oscillation frequency, current, or voltage.

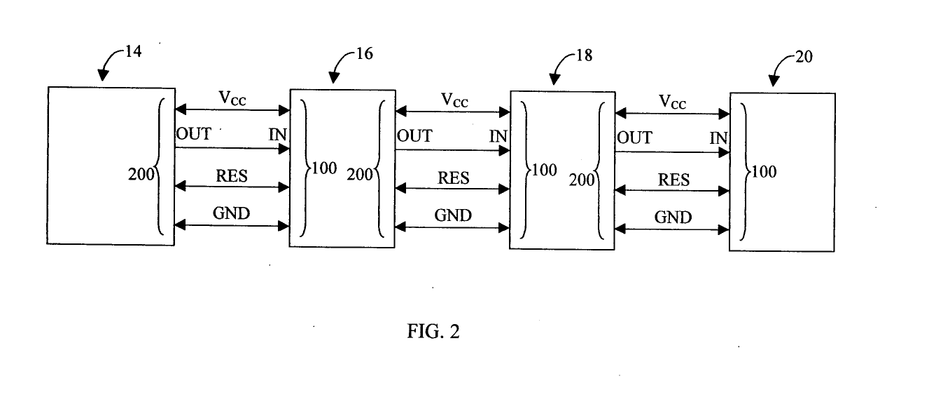

Turning to FIG. 2, in one embodiment the input port 100 of each module comprises four inputs: V_{CC} (power), IN (input), RES (resistance) and GND (ground). The output port 200 of each module comprises four outputs: V_{CC} (power), OUT (output), RES (resistance) and GND (ground).

As shown in FIG. 2, module 16 is directly attached to base 14. Module 18 is directly attached to module 16, and module 20 is directly attached to module 18, forming a sequence of modules, in this case including three modules. V_{CC} of output port 200 of base 14 is electrically connected to V_{CC} of input port 100 of module 16. V_{CC} of output port 200 of module 16 is electrically connected to V_{CC} of input port 100 of module 18, and V_{CC} of output port 200 of module 18 is electrically connected to V_{CC} of input port 100 of module 20. In each module, V_{CC} of the input port and V_{CC} of the output port are connected internally, which results in V_{CC} being continuously connected electrically between the base and all of the modules, forming a common power bus. Similarly, the RES and GND connections are connected the same way, where these electrical connections are continuous between the base and all of the modules. In this bus configuration, the RES and GND connections are shared by the base and all of the modules.

The OUT and IN lines work differently from the V_{CC}, GND and RES lines. Instead of a bus configuration, the OUT of the output port is connected to the IN of the input port of the following module only. Also, within each module, IN on the input port is not connected to the OUT on the output port internally. OUT of output port 200 of module 16, for example, is only connected to IN of input port 100 of module 18. The OUT of output port of module 18 is only connected to IN of input port of module 20.

In this embodiment, when the base 14 is not performing the identifying process, it sets its OUT connection high, to V_{CC}; thus the IN connection on module 16 is high. This also causes all of the modules in the sequence, in this example 16, 18, and 20, to set their OUT connections high.

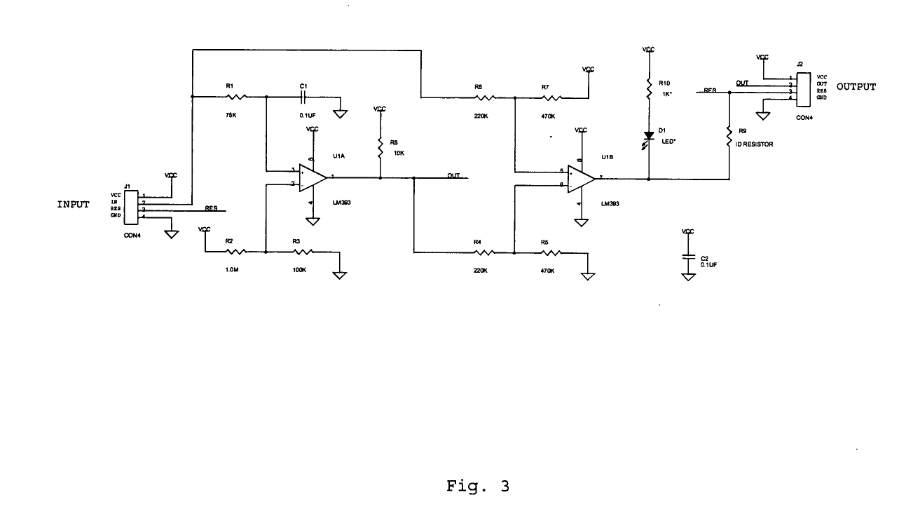

FIG. 3 shows one possible circuit design for a module which 1) becomes active when its IN port goes low, 2) puts its ID resistor on the resistor bus for a time period, then 3) removes its ID resistor from the resistor bus and substantially simultaneously activates the next module by setting its own its own OUT port low. A module provides its identity by putting its ID resistor on the resistor bus RES. Clearly other designs are possible; FIG. 3 only serves to illustrate a preferred embodiment.

In FIG. 3, assume V_{CC} is applied to IN. This is the state when the base is not actively scanning the modules. Voltage on the minus input (V₋) to first LM393 comparator U1A is about 0.091 V_{CC}, while, initially, voltage to the plus input (V₊) to U1A is almost equal to V_{CC}. While V₊ is greater than V₋ for comparator U1A, its output is in a high-impedance state. In this state, the pull-up resistor R8 causes the OUT connection on the output port to be set to V_{CC}. Consequently, during this time period, V₊ to the second LM393 comparator U1B is about equal to V_{CC}, while V₋ to comparator U1B is 0.67 V_{CC}. Thus this output is also in a high-impedance state, and ID resistor R9 is not electrically connected to the resistor bus RES. During this period the module is inactive.

When an identification sequence starts, the base 14 (in FIG. 2) sets its OUT connection low. This causes the IN connection on module 16 to be low, and module 16 becomes active. A module is active when its IN connection is low and its OUT connection is high.

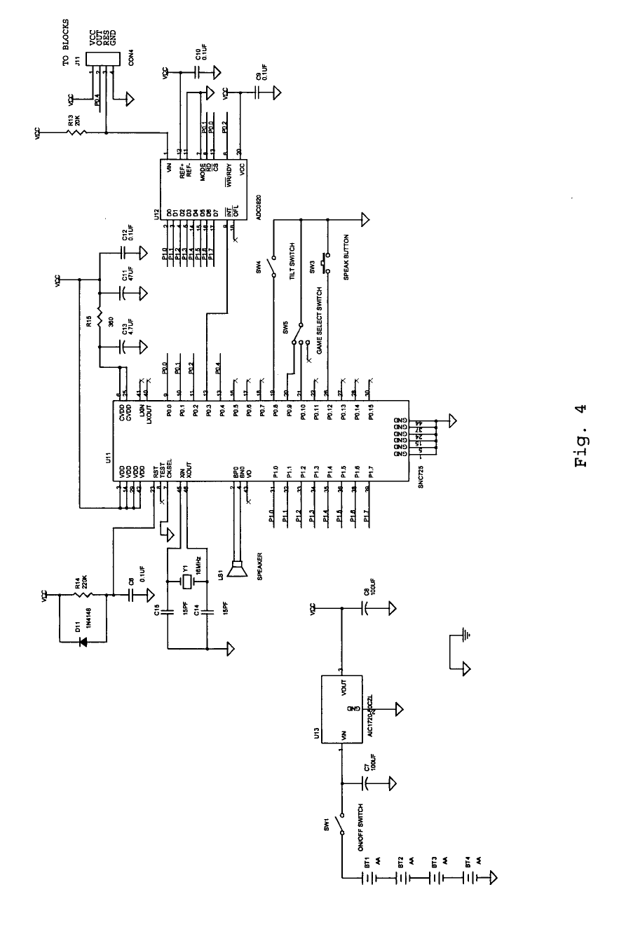

FIG. 4 shows a possible embodiment for a base. Microcontroller U11 controls the module identification process. Analog to digital converter U12 is used by microcontroller U11 to measure the voltage on resistor bus RES. FIG. 4 shows four AA batteries BT1-BT4, and U13 is a low-drop-out voltage regulator which outputs 5 volts. Microcontroller U11 has a PWM speaker output for directly driving speaker LS1. J11 is the output port where a module can be attached.

This description will refer to both FIG. 3 (a module) and FIG. 4 (the base.) In FIG. 3, while a module is active, the output of the comparator U1B is GND, causing the ID resistor R9 in the module to be electrically connected between GND and resistor bus RES. In this embodiment, (in FIG. 4) the base has a fixed reference resistor R13 connected between resistor bus RES and V_{CC}. The ID resistor R9 (FIG. 3) and reference resistor R13 (FIG. 4) form a voltage divider that determines the voltage on resistor bus RES. The base can read this voltage and determine the value of ID resistor R9 by the following equation:
R9=V_{RES}/(V_{CC}−V_{RES})*R13
where V_{RES} is the voltage on resistor bus RES.

As shown in FIG. 3, when a module's IN connection goes low, comparator U1A does not change state right away because of the time constant of C1 and R1, but the comparator U1B changes state right away, because its V₊ input suddenly goes to 0.32 V_{CC}. This causes the output of U1B to be switched to GND, which causes the ID resistor R9 to be attached between resistor bus RES and GND, allowing the base to read back the voltage on resistor bus RES to determine the identity of this module. This is the active state for the module. Also, when the IN connection goes from high to low, capacitor C1 discharges through the resistor R1, which causes the voltage on V₊ of U1A to drop. After a time period, V₊ is less than V for comparator U1A. When V₊ is less than V₋, the output goes to GND. At this point the module becomes inactive. The OUT pin has gone low, triggering the next module to be the active module. In this second inactive state, IN and OUT are both low. Now V to comparator U1B is at GND, while V₊ remains about 0.32 V_{CC}. Thus V₊ is greater than V₋ for comparator U1B and the output becomes high-impedance, and the ID resistor R9 is disconnected from resistor bus RES. The OUT connection going low causes the module to be inactive, and causes the next module to become the active module.

Once the module has been active for the time set by the R1/C1 time constant, it sets its OUT low. OUT is connected to IN of the following module. Turning back to FIG. 2, once module 16 has timed out, it sets OUT of output port 200 of module 16 low, causing IN of input port 100 of module 18 to be low. Module 16 is no longer active, and module 18 is now active. As before, module 18 identifies itself by putting its ID resistor on the resistor bus RES, allowing the base to identify it.

Once module 18 times out, it activates the next module, module 20.

Once it has become active, module 20 identifies itself, then sets its OUT low. Since there is no module following module 20, there is no active module. The base 14 senses the resistor bus, and senses that there is a very high resistance to ground, since the resistor bus RES voltage will be equal to V_{CC}. This is interpreted to mean that there is no module following module 20, and thus module 20 is the last module in the sequence.

The time period during which a module is active is not crucial, but its approximate length should preferably be known, should be substantially the same for all modules in the sequence and must be long enough for the module to be identified. If desired, other activities can take place while the module is active; LEDs on the module could be lit, for example, or a sound can be made, either by the module or by the base.

In this embodiment, from the perspective of the base, during identification of a sequence, the base 14 first sets its output low, which is IN to the first module. It then starts continually measuring the resistance on the resistor bus RES. It detects a first resistance (while the first module is active), then a second resistance (while the second module is active), then a third, and so on until it finally detects a very high resistance, indicating the end of the sequence. Two or more adjacent modules can, of course, have the same resistance, and thus the same identity; in the alphabet block example, suppose the user has selected blocks to spell the word M-O-O-N. In this case the base will be able to distinguish the second O from the first because the resistance will remain at the value associated with “O” for twice the time period usually required to identify a module.

For the period during which a module is active, its ID resistor is sensed on the resistor bus RES, and it can be identified. Putting its ID resistor on the resistor bus RES is one way a module can be said to identify itself. This description speaks of the base identifying a module, a module identifying itself, or a module providing its identity; these are considered to be equivalent.

Software can interpret values on resistor bus RES to determine when one module has finished being active and the next has begun. An example is described here. This is one example only; many others can be envisioned and routinely executed by the skilled practitioner.

The following pattern must be interpreted: While a module is active, the voltage on resistor bus RES is stable. When one module is becoming inactive and causing the next module to become active, voltage ramps (up or down) rapidly, then restabilizes at a new value once the next module is active. The resistor bus RES will be sampled, and the sampling interval should be significantly shorter than the active period of a module. (The sampling interval can advantageously be such that, for example, ten samples take place during an active period.)

Thus the pattern of voltages sampled from resistor bus RES will be (1) during the active period of a module, several subsequent sampled values will be the same, then (2) during the rapidly changing ramp to the next module, several subsequent sampled values will be different from each other, then (3) during the active period of the next module, several subsequent sampled values are the same, at a value different from the first stable voltage. This stable-ramp-stable pattern continues to the end of the sequence.

In order to identify a module, the stable voltage during an active period only is of interest, while the rapidly changing values between active periods of adjacent modules are not. The time period during which a stable voltage remained stable is also of interest, since repeated values (two or more identical letters, for example) in a sequence are identified this way.

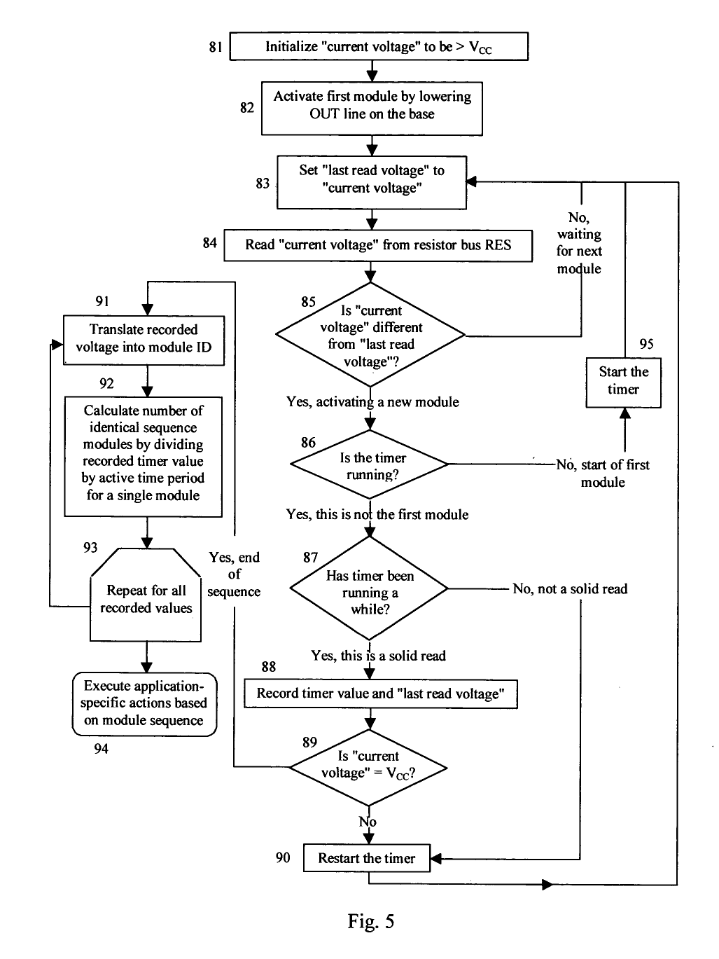

One possible implementation of the software, the steps of which are shown in FIG. 5, thus seeks to record voltage and elapsed time only when the voltage first changes after a period of stability; i.e. after an active period. Several subsequent reads all different from each other indicate a ramp and are not of interest, and thus are not recorded.

To accomplish this, a timer is reset every time the sampled value is different from the previous sampled value. A critical interval must be established, which will depend on the characteristics of the electronics, but should be less than half the active period (advantageously significantly less), but significantly longer than the sample interval.

Turning to FIG. 5, identification of a sequence of modules is begun in startup step 81 through step 86. At step 86, it is determined that the timer must be started, the timer is started (step 95), and looping begins back at step 83. This description will begin at step 83 when the first module is active and the timer has been started. During the active period of a module, the sampled voltage is unchanged, and the timer runs while sampling continues, in steps 83 through 85.

When a voltage is read that is different from the previous one, the time elapsed since the last change is checked (step 87.) If the time elapsed is longer than the critical interval (“Yes” branch from step 87), then the voltage has just changed after a period of stability; i.e. after the active period of a module. The previous voltage (which will identify that module) should be recorded, as should the time period during which that value was stable (step 88.) If the voltage just read is anything other than V_{CC} (step 89), the timer is reset (step 90) and sampling continues (return to step 83.)

If, however, at step 87, the time elapsed since the last change was shorter than the critical interval (the “No” branch), the sample was taken during a rapidly changing ramp. The value is not of interest. The timer is reset (step 90) and sampling continues (return to step 83.)

If at any point a new changed voltage is found to be V_{CC}, the end of the sequence has been reached (the “Yes” branch from step 89.)

Once the end of the sequence has been reached, each recorded voltage is translated into a module ID, by, for example, a lookup table (step 91), and repeated values are identified using timer values that are longer than the active period (step 92); this is repeated (step 93) until the end of the sequence. Actions can be then performed based on the identified sequence of modules as desired (step 94.)

Actual time periods for the active period, the sampling interval, and the critical interval will depend on the electrical characteristics of the components selected, and thus will vary in ways familiar to the skilled practitioner.

Digital Means of Identification

If the means of storing the identity of a module are digital, then a digital value is stored in the module.

One way to implement digital means is to store a digital value for each module in a known number of bits. In the example here, eight bits will be used, allowing for two-hundred-fifty-six possible identities; clearly there could be more or fewer. The bits can be stored by means of jumpers connecting input lines directly to V_{CC} or to GND to represent a binary number, or by a memory device, among others.

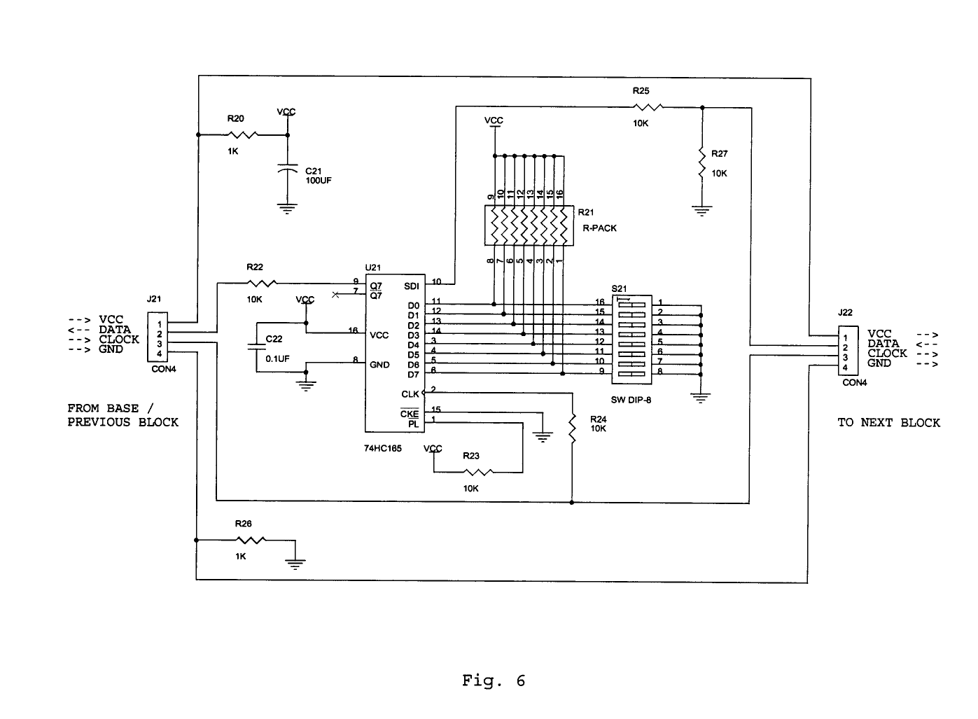

In a preferred embodiment, the entire sequence of modules could make up a shift register chain. There could be, for example, eight bits in each module. If there are six modules in a sequence of modules, for example, the shift register chain will be 48 bits long. Suppose, in this example, the modules are letter blocks, and binary value 00000001 corresponds to the letter A, 00000010 to letter B, 00000011 to letter C, etc. Thus the value 00000001 is stored in every A block, 00000100 in every D block, etc. FIG. 6, a circuit diagram of a preferred embodiment for a module, shows this value being stored in an 8-bit DIP switch S21.

This example uses four pins into each module, V_{CC}, DATA, CLOCK, and GND. It uses a 74HC165 CMOS IC for the shift register. The base can momentarily pulse the V_{CC} line low, which would cause a low pulse on the /PL (parallel load) pin of the 74HC165, causing each module to load its identity from the 8-bit DIP switch S1 into the bits of the shift register. The momentary low pulse on V_{CC} would not affect the power (V_{CC}) pin of each 74HC165, because of the series resistor R20, the large capacitor C21 on the V_{CC} pin, and the very low current consumed by the 74HC165. Thus when the base puts out a momentary low pulse on the V_{CC} pin, the identities of all of the modules in the sequence will be loaded into the shift register chain. In this step each module provides its identity. Subsequently, each rising edge on the CLOCK pin causes the data in the shift register to shift toward the base one bit, until, bit by bit, the module identities in the shift register are shifted into the base via the DATA line. As can be seen in FIG. 6, each of the input and output port signals which go to the 74HC165 has a series resistor associated with it. This is to reduce the damaging currents associated with an ESD discharge which could enter the block through the input or output ports. The end of the sequence is identified when, for example, the ID read is equal to zero.

It would also be possible for the module to provide other digital information along with its identity. For example, using the example given earlier in which each module is a pipe segment in an underground pipeline, information about the volume of flow through the pipe segment could be provided along with the pipe segment's identity. Many other examples can be imagined.

In most anticipated environments of use, if digital means are used, storing a digital identity by way of jumpers, switches, or some other robust means is preferred to storing the identity in a nonvolatile memory device. In general, nonvolatile memory devices are CMOS or bipolar. CMOS memory is susceptible to electrostatic discharge. Expected conditions of use if the present invention is used as a toy would be likely to expose it to electrostatic discharge. Bipolar memory, on the other hand, requires a relatively large amount of current. If the present invention is to be used in a battery-operated toy, the current required by bipolar memory would lead to short battery life. If, however, the invention is to be operated in an environment in which these disadvantages are overcome, for example if it could be plugged into a power source rather than battery-powered, or if it could be effectively shielded from electrostatic discharge, either of these non-volatile memory alternatives could be advantageous.

An important advantage of all of the embodiments described above, and many other possible embodiments, is that each module doesn't require its own power source, such as batteries.

The base and modules can include hardware and/or software to allow them to react to the identification of the order and number of modules in a sequence. If the modules are lettered blocks, for example, the base may be able to recognize when the letters spell out words, and report completed words to the user. In other cases, the base could recognize and report when the user has successfully constructed a sequence of modules to match some known pattern, for example a string of musical notes, a list of numbers, or an arrangement of colors. Countless reactions are possible, and examples are provided here for clarification, and are not intended to limit the scope of the invention.

The mechanical design of a module is most advantageously chosen to ensure that only input ports are directly attached to output ports and vice versa. For example, male-female fittings as used in plastic building blocks would be an advantageous choice, with tabs paired with either input or output ports, and holes paired with the opposite type of port. Velcro-style attachments would also work, with hooks paired with either input or output ports, and loops paired with the opposite type of port. Attachments would be configured so that when the male-female fittings, Velcro-style attachments, or other attachments are mechanically connected, the appropriate connections of the ports are in contact, e.g. V_{CC} to V_{CC}, GND to GND, etc. Many other styles of mechanical attachment can be envisaged.

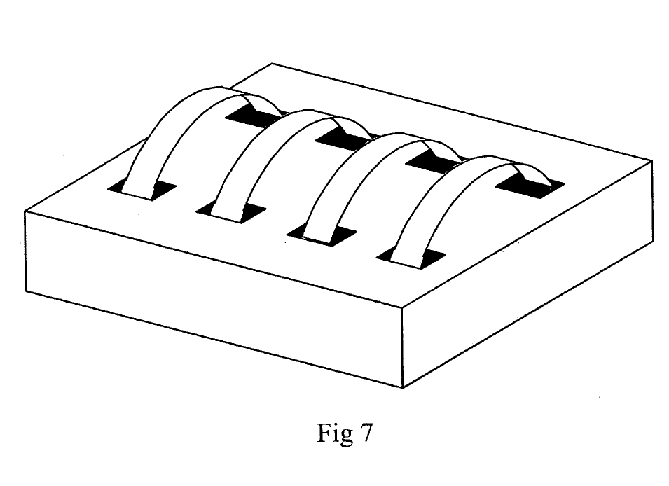

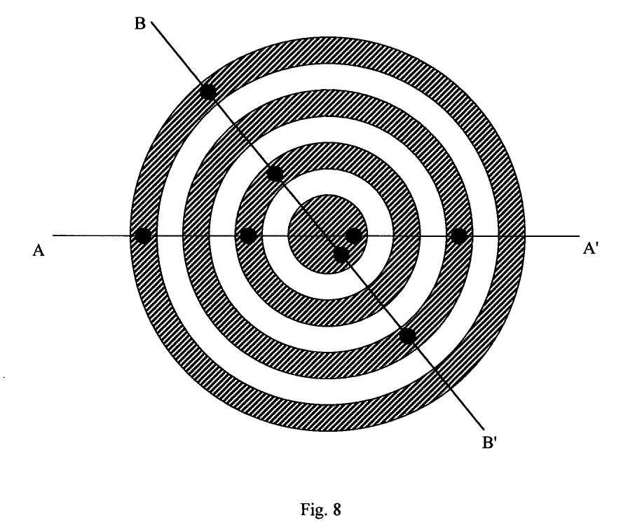

Many types of electrical contacts can be used. In one embodiment, the four contacts (corresponding to the four input and output pins of the example above, in which ID is stored in an ID resistor) on one port, either the input or output port, of each module can be leaf spring contacts, as shown in FIG. 7. Leaf spring contacts are commercially available, and are frequently used in the cordless phones to make contact to the handset for recharging. The male contacts are normally used in the cordless phone base, and can be used for the input port of each module. On the other port, which is normally on the opposite side of the module, can be contacts formed in concentric circles, as in FIG. 8. To simplify discussion, suppose the leaf spring contacts are the input port contacts, used, for example, on input ports 100 of modules 16, 18, and 20, while the contacts in concentric circles are used on output ports 200 of base 14 and modules 16, 18, and 20 of FIG. 2.

It will be seen that the concentric circle design of the contacts shown in FIG. 8 allows that so long as the input port of one module is in contact with the output port of another, and the centers of these contacts are roughly aligned, individual modules can be rotated about an axis connecting the center of its input and output ports while still retaining contact, for example contacting at the points shown along line A-A′ or, after rotation, along line B-B′. This means, for example, that a cube-shaped (six-sided) letter block with an input port in one side and an output port on the opposing side can be directly attached to another block with any of the remaining four sides “up”, or facing the user, for four possible orientations. A cylinder-shaped module, for example, could be rotated fully about its long axis and remain in contact with directly attached modules.

While the most straightforward arrangement for input and output ports is to be on opposite sides of a module, it is of course possible to imagine alternate arrangements. For example, a cube-shaped module could have an input port on one side and an output port on an adjacent side, rather than the opposing side, so that a sequence of modules could have a ninety-degree bend when this module is included in the sequence.

Most examples given so far have described a single base directly attached to a sequence of modules comprising an arbitrary number of modules. Other configurations are possible.

One useful configuration would be a single base with more than one output port, wherein a sequence of modules can be attached to each output port. The ports can be adjacent, or on opposing sides of the base, or in any other orientation. Each sequence might be identifiable. Alternately, more than one base could be directly attached to a single sequence. Conceivably embodiments of the invention could include branching sequences of modules. These alternate embodiments would still fall within the scope of the invention.

The foregoing detailed description has described only a few of the many forms that this invention can take. For this reason, this detailed description is intended by way of illustration, and not by way of limitation. It is only the following claims, including all equivalents, which are intended to define the scope of this invention.

1. An apparatus comprising:
a first base; and
a plurality of modules each having an identity,
said base and modules comprising circuitry wherein:
when a first module is attached to the first base, and
an arbitrary number of modules of the plurality of modules are attached, directly or indirectly, to the first module, the circuitry determines an order and the identities of all attached modules.

2. The apparatus of claim 1 wherein the arbitrary number is greater than one.

3. The apparatus of claim 2 wherein any module can be attached to:
the first base, or
one other module, or
the first base and one other module, or
two other modules, or
the first base and a second base.

4. The apparatus of claim 1 wherein only one module can be directly attached to the first base at a time.

5. The apparatus of claim 1 wherein more than one module can be directly attached to the first base at a time.

6. The apparatus of claim 1 wherein the identity of each module is stored within that module.

7. The apparatus of claim 6 wherein the identity of at least one module is stored by analog means.

8. The apparatus of claim 7 wherein the analog means of storing the identity of at least one module comprises a resistor.

9. The apparatus of claim 6 wherein the identity of at least one module is stored by digital means.

10. The apparatus of claim 7 wherein the digital means of storing the identity of at least one module comprises jumpers or switches.

11. The apparatus of claim 7 wherein the digital means of storing the identity of at least one module comprises a memory device.

12. The apparatus of claim 6 wherein the identity of at least one module corresponds to a letter.

13. The apparatus of claim 6 wherein the identity of at least one module corresponds to a number.

14. The apparatus of claim 6 wherein the identity of at least one module corresponds to an image.

15. The apparatus of claim 6 wherein the identity of at least one module corresponds to a word.

16. The apparatus of claim 6 wherein the identity of at least one module corresponds to a color.

17. The apparatus of claim 6 wherein the identity of at least one module corresponds to a sound.

18. The apparatus of claim 17 wherein the identity of at least one module corresponds to a musical tone.

19. An apparatus comprising:
a first base;
a plurality of modules, each having an identity and being directly attachable to the first base or other modules; and
circuitry, wherein the circuitry determines an order and the identities of all contiguously attached modules when one of the modules is attached to the first base.

20. The apparatus of claim 19, wherein the first base and the modules comprise the circuitry.

21. The apparatus of claim 20, wherein the identity of a module is stored by analog means.

22. The apparatus of claim 21, wherein the analog means comprise a resistor within the module.

23. The apparatus of claim 20, wherein the identity of a module is stored by digital means.

24. The apparatus of claim 23, wherein the digital means comprise jumpers or switches.

25. The apparatus of claim 23, wherein the digital means comprise a memory device.

26. A method of identifying order and number of modules in a sequence of modules attached to a base, each module having an identity, the method comprising:
the base initiating an identification sequence; and
each module providing its identity, wherein
only one module of the sequence is directly attached to the base.

27. The method of claim 26 wherein:
the step of the base initiating an identification sequence comprises the base activating a first module, causing it to become the active module; and
the step of each module providing its identity comprises:
1) the active module identifying itself; and,
2) for each remaining module of the train until the end of the string:
the active module activating its following module, making itself inactive and making the following module become the active module; and
the active module identifying itself.

28. The method of claim 27 wherein the step of a module providing its identity comprises using analog means.

29. The method of claim 28 wherein the analog means comprise a resistor

30. The method of claim 27 wherein the active module turns on a light within the module while it is the active module.

31. The method of claim 26 wherein:
the sequence of modules comprises a shift register chain, and the step of each module providing its identity comprises loading its identity into the shift register chain.

32. The method of claim 31, wherein the method further comprises, after the step of each module providing its identity, the module identities in the shift register chain being shifted into the base.

33. The method of claim 32, wherein the identity of at least one module is stored in jumpers or switches.

34. The method of claim 33, wherein the identity of at least one module is stored in a memory device.

35. The method of claim 27 wherein the step of a module providing its identity comprises using digital means.

36. The method of claim 27 wherein at least one module provides other digital information along with its identity.
